(19) United States
(12) Patent Application Publication
(10) Pub. No.: US 2007/0209981 A1
(43) Pub. Date: Sep. 13, 2007

(54) Replaceable Cartridge Filtering Jug

(76) Inventor: Maurizio Moretto, Vicenza (IT)

Correspondence Address: RATNERPRESTIA, P O BOX 980, VALLEY FORGE, PA, 19482-0980, US

(21) Appl. No.: 10/593,732

(22) PCT Filed: Nov. 3, 2004
(86) PCT No.: PCT/EP04/12391

§ 371 Date: Sep. 21, 2006

(30) Foreign Application Priority Data
Apr. 8, 2004 (IT) PD2004A000095

(51) Int. Cl. B01D 35/14

(52) U.S. Cl. 210/121; 210/91; 210/86; 210/138; 210/464; 210/474

(57) ABSTRACT

Replaceable cartridge filtering jug including a for containing water requiring filtration and a vessel for the collection of filtered water in which the vessels are connected through the cartridge together with a device for counting the filtering cycles performed by the cartridge to determine the state of exhaustion of the cartridge. The device for counting the filtering cycles includes at least one float level detector associated with one of the vessels and capable of generating at least one counting signal fed to a counter as a result of the corresponding water level being reached within the associated vessel.

This application is a U.S. National Phase Application of PCT International Application PCT/EP2004/012391 and incorporated by reference herein.

### TECHNICAL FIELD OF THE INVENTION

The invention relates in general to a replaceable cartridge filtering jug, and more particularly to a filtering jug that counts the filtering cycles performed by the filter.

### BACKGROUND ART

Filtering jugs of the abovementioned type are widely used to render drinking water drinkable and/or to render its taste more pleasing.

They are based on the principle of filtering the water which has to be treated through a filtering cartridge. The cartridge has a predetermined useful life and must be replaced at the end of its useful life. It is therefore important to monitor the extent of its exhaustion.

Various devices to monitor the state of exhaustion within filtering jugs of the abovementioned type are known. These devices are based on counting systems, generally of the mechanical or electronic type.

### BRIEF DESCRIPTION OF THE INVENTION

The main object of the invention is to provide a replaceable cartridge filtering jug which has been functionally and structurally designed to monitor exhaustion of the cartridge effectively and at the same time economically.

An objective of the invention is accomplished through a replaceable cartridge filtering jug, including a vessel for containing water requiring filtration and a vessel for the collection of filtered water. The vessels are connected through the cartridge, as well as by means for counting the filtering cycles performed by the cartridge to determine the exhaustion state of the cartridge. The counting means includes at least one float level detector associated with one of the vessels and capable of generating at least one counting signal fed to the counting means as a consequence of the corresponding water level being reached within the associated vessel.

### BRIEF DESCRIPTION OF THE DRAWINGS

Advantages and characteristics of the present invention will become clearer from the following detailed description which is given with reference to the appended drawings which are provided purely by way of non-limiting example and in which:

FIG. 1 is a diagrammatical view in cross-section of a filtering jug according to the invention,

FIG. 2 is a view along cross-section II-II of a detail of the filtering jug in FIG. 1,

FIG. 3 is a diagrammatical view in cross-section of a first variant embodiment of the invention,

FIG. 4 is a diagrammatical view of a second variant embodiment of the invention.

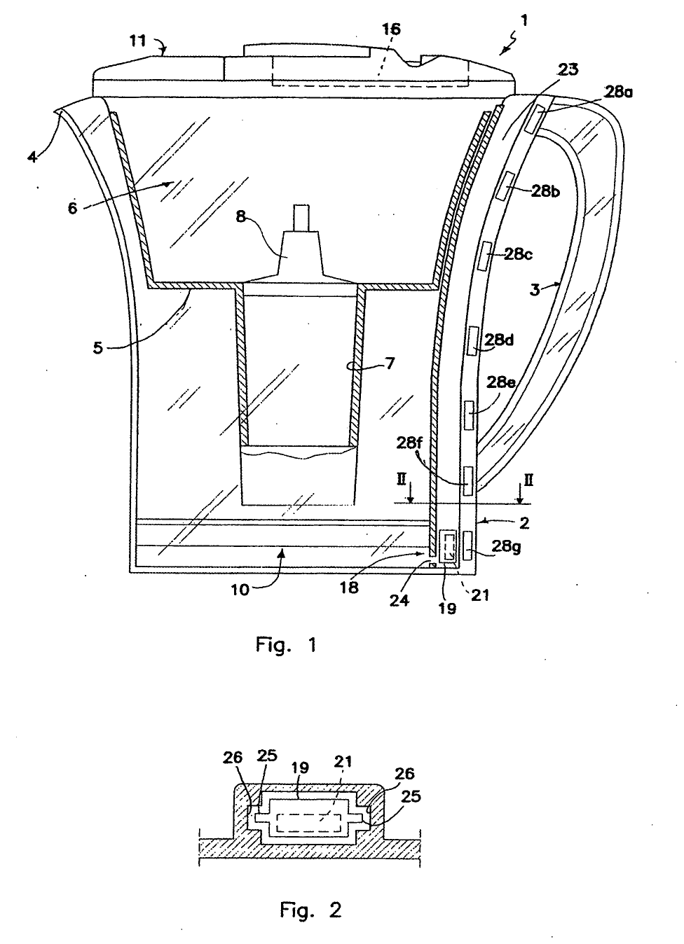

### BEST MODE FOR CARRYING OUT THE INVENTION

In the figures, the numeral designation 1 indicates as a whole a filtering jug including a container 2 with a handle 3 and an opposing pouring spout 4. A hopper 5 forming a first vessel 6 designed to receive water requiring filtration, at the bottom of which there opens an outflow duct 7 designed to receive a filtering cartridge 8 of a replaceable type, which is removably housed within container 2. Within container 2 there is also defined a second vessel 10 for collection of the filtered water.

Container 2 is removably closed by a lid 11 which may be provided with an opening panel for filling first vessel 6.

The operation of treating the water takes place by placing water requiring filtration in first vessel 6 after removing lid 11 or after opening the panel in such a way that the water passes through conduit 7 passing through the filtering bed located in cartridge 8 and then collects in second vessel 10.

Means to count the filtering cycles performed are provided in order to determine the end of the useful life of cartridge 8, after which it must be considered that the cartridge is exhausted and must therefore be replaced with a new cartridge. These counting means comprise a counting and calculation device indicated as a whole by 16, which may be provided with displays, indicator means and/or other visual means not shown, with which a floating level indicator indicated as a whole by 18 is associated.

This floating level indicator 18 is mounted in second vessel 10 and comprises a float 19, as well as a proximity sensor which senses the position of the float.

In the example illustrated in FIG. 1 there is provided a plurality of proximity sensors 28a, 28b, 28c, 28d, 28e, 28f, 28g. Sensor 28g, which is used to identify a condition in which the jug is completely drained (reference level) is located close to the bottom of second collection vessel 10, while the other sensors are located in an intermediate position at higher levels between reference sensor 28g and terminal sensor 28a which corresponds to the condition in which the jug is filled to a maximum.

In a preferred arrangement the proximity sensors comprise switches of the reed, hall and/or magneto-resistant type and the float bears a magnetic stop 21 which is capable of acting together with the aforesaid switches in order to close the circuit. Switches of a different type, which are in themselves known, may be used as an alternative.

Float 19 is preferably housed in a compensation chamber 23 which communicates with corresponding vessel 10 through a gauged opening 24. This opening 24 lies close to the bottom of vessel 10.

The float is guided within the compensation chamber through two lateral appendages 25 running in corresponding groove guides 26 in the chamber.

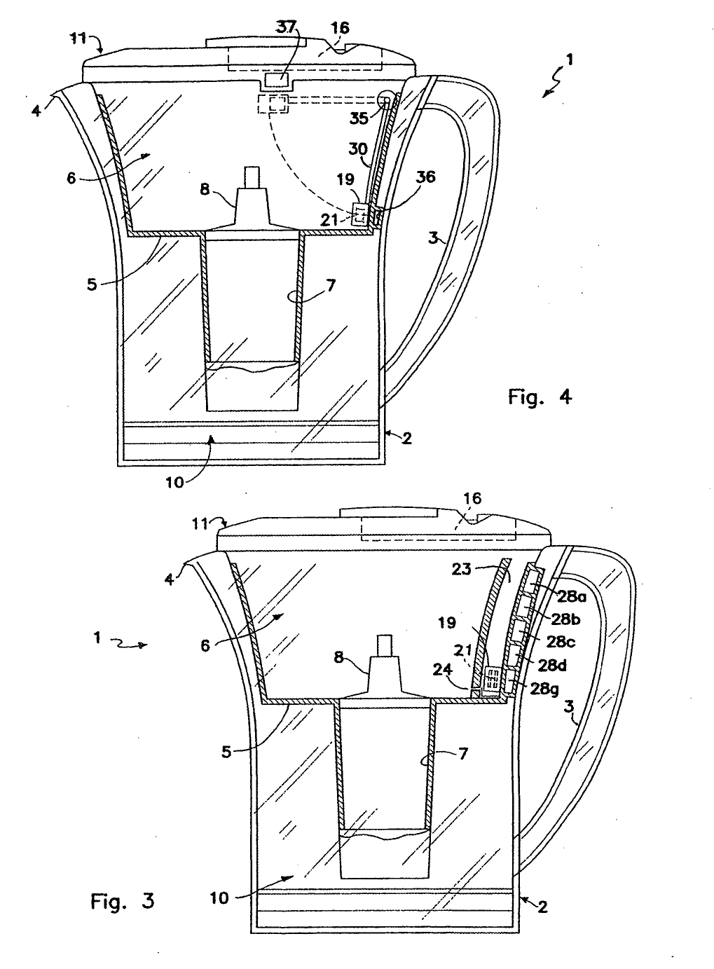

In the example in FIG. 3, where similar details bear the same reference numbers as in the previous example, the entire float level detector device is located in first vessel 6 which receives the water which is to be filtered.

In the example in FIG. 4, float 19 is mounted at one end of a tilting arm 30 whose opposite end is hinged at 35 to the wall of corresponding vessel 6. In this case too, float 19 has a magnet 21 which is capable of acting together with corresponding proximity sensors 36, 37 located at the bottom of first vessel 6 and at the lid respectively.

The jug according to this invention operates as follows. When vessel 6 which receives the water requiring filtration is filled, the latter flows through cartridge 8 into second vessel 10. The level in the latter rises as a consequence from a minimum level (empty vessel—sensor 28g) to a completely filled level (complete jug and vessel 6 full—sensor 28a). As the level rises the water in vessel 10 flows through opening 24 in the compensation chamber, increasing its level. As a consequence the float is caused to be displaced from sensor 28g to top sensor 28a, or as far as the intermediate sensor corresponding to the final level reached in the collecting vessel.

The counting signal generated is evaluated for example by monitoring whether the same has been maintained for a predetermined time, in order to eliminate or avoid any disturbing factors resulting from handling of the jug.

The counting signals generated are then summed by calculating unit 16 which generates a display indicating the state of exhaustion of the cartridge. This display may for example comprise a representation of the number of cycles performed, the litres of water filtered, the remaining litres until the cartridge is exhausted or the residual filtering cycles until the cartridge is exhausted.

Operation of the embodiments in FIGS. 3 and 4 is substantially equivalent, wherein the guided movement of float 19 is replaced by a corresponding tilting of the supporting arm in the case of the jug in FIG. 4.

The invention thus provides many advantages in comparison with the counting mechanisms hitherto known, among which are a relatively low manufacturing cost, optimum reliability of the counting system, and the possibility of taking partial fillings of the jug into account through the presence of multiple sensors.

1. Replaceable cartridge filtering jug, comprising: a vessel for containing water requiring filtration and a vessel for the collection of filtered water, the vessels being connected through the cartridge, as well as means for counting the filtering cycles performed by the cartridge to determine the exhaustion state of the cartridge, the counting means comprise at least one float level detector associated with one of the vessels and capable of generating at least one counting signal fed to the counting means as a consequence of the corresponding water level being reached within the associated vessel.

2. The filtering jug according to claim 1 in which the level detector comprises at least one proximity sensor which senses the position of the float.

3. The filtering jug according to claim 2 in which the at least one proximity sensor comprises a switch.

4. The filtering jug according to claim 3 in which the switch is of the reed, hall and/or magneto-resistant type and the float has a magnetic stop which is able to co-operate together with the switch.

5. The filtering jug according to claim 1 in which the float is housed in a compensation chamber communicating with the associated vessel through a gauged opening.

6. The filtering jug according to claim 5 in which the float is guided within the compensation chamber.

7. The filtering jug according to claim 1 in which the float is mounted at one end of a hinged arm whose opposite extremity is hinged on the associated vessel.

8. The filtering jug according to claim 1 in which the level detector comprises a plurality of sensors located at rising levels within the associated vessel.

9. The filtering jug according to claim 2 in which the float is housed in a compensation chamber communicating with the associated vessel through a gauged opening.

10. The filtering jug according to claim 3 in which the float is housed in a compensation chamber communicating with the associated vessel through a gauged opening.

11. The filtering jug according to claim 4 in which the float is housed in a compensation chamber communicating with the associated vessel through a gauged opening.

12. The filtering jug according to claim 2 in which the float is mounted at one end of a hinged arm whose opposite extremity is hinged on the associated vessel.

13. The filtering jug according to claim 3 in which the float is mounted at one end of a hinged arm whose opposite extremity is hinged on the associated vessel.

14. The filtering jug according to claim 4 in which the float is mounted at one end of a hinged arm whose opposite extremity is hinged on the associated vessel.

15. The filtering jug according to claim 2 in which the level detector comprises a plurality of sensors located at rising levels within the associated vessel.

16. The filtering jug according to claim 3 in which the level detector comprises a plurality of sensors located at rising levels within the associated vessel.

17. The filtering jug according to claim 4 in which the level detector comprises a plurality of sensors located at rising levels within the associated vessel.

18. The filtering jug according to claim 5 in which the level detector comprises a plurality of sensors located at rising levels within the associated vessel.

19. The filtering jug according to claim 6 in which the level detector comprises a plurality of sensors located at rising levels within the associated vessel.

20. The filtering jug according to claim 7 in which the level detector comprises a plurality of sensors located at rising levels within the associated vessel.

21. The filtering jug according to claim 1, wherein counting signals are summed by a calculating unit which generates a display indicating the state of exhaustion of the cartridge.

22. The filtering jug according to claim 21, wherein the calculating unit is disposed in a lid of the filtering jug.
